(19) United States
(12) Patent Application Publication
(10) Pub. No.: US 2010/0141139 A1
(43) Pub. Date: Jun. 10, 2010

(54) Protective layer for plasma display panel, method of preparing the protective layer, and plasma display panel including the protective layer

(76) Inventors: Min-Suk Lee, Suwon-si (KR); Kwang-Jong Suh, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/591,426

(22) Filed: Nov. 19, 2009

(30) Foreign Application Priority Data
Dec. 8, 2008 (KR) 10-2008-0124299

(51) Int. Cl. H01J 17/49; H01J 9/20; C09D 1/00

(52) U.S. Cl. 313/582; 445/58; 106/286.1

(57) ABSTRACT

A protective layer for a PDP, includes a doping source layer containing at least one dopant, and a body layer which contacts the doping source layer and includes at least one dopant diffused from the doping source layer. The protective layer is capable of reducing dopant loss and avoiding trade-offs/conflicts between a donor dopant and an acceptor dopant.

### BACKGROUND

1. Field

Embodiments relate to a protective layer for a plasma display panel (PDP), a method of preparing the protective layer, and a PDP including the protective layer.

2. Description of the Related Art

Conventionally, a protective layer for a PDP is formed by depositing a source material, formed of magnesium oxide (MgO) doped with an appropriate dopant for changing bandgap information, e.g., electron affinity, bandgap energy, defect level-F center, donor level, acceptor level, etc., onto a dielectric layer. Conventionally, a doping operation is performed during fabrication of the source material.

### SUMMARY

Embodiments are therefore directed to a protective layer for PDP, method of preparing the protective layer, and PDP including the protective layer.

It is therefore a feature of an embodiment to provide a protective layer for a PDP, in which loss of a dopant is reduced to maintain bulk characteristic of MgO containing the dopant, a method of preparing the protective layer, and a PDP including the protective layer.

It is therefore another feature of an embodiment to provide a protective layer for a PDP, the protective layer for avoiding trade-offs/conflicts between a donor dopant and an accept dopant, a method of preparing the protective layer, and a PDP including the protective layer.

At least one of the above and other features and advantages may be realized by providing a protective layer for a PDP including a doping source layer containing at least one dopant, and a body layer in contact with the doping source layer and includes at least one dopant diffused from the doping source layer.

The doping source layer may contain a donor dopant, an acceptor dopant, or a mixture thereof or may include a first doping source layer containing a donor dopant and a second doping source layer containing an acceptor dopant. The donor dopant may be at least one of Sc, Al, Y, Ga, B, La, Ce, Pr, Nd, Sm, Eu, Gd, Tb, Dy, Ho, Yb, Si, Cs, F, H, or Er. The acceptor dopant may be at least one of Li, Na, K, Ag, Cu, Ni, Ca, Sr, Ba, V, Zn, Cr, In, Hf, Zr, Ge, or C.

At least one of the above and other features and advantages may also be realized by providing a method of fabricating a protective layer for a PDP, the method including forming a doping source layer containing at least one dopant on a substrate, drying the doping source layer, and depositing a body layer onto the doping source layer.

The method of fabricating a protective layer for a PDP may further include forming a dielectric material layer on the substrate.

The doping source layer may be formed by including a solution containing the at least one dopant and a solvent onto the substrate using at least one of spraying, printing, dipping, spin coating, and inkjet method.

The method may further include firing the doping source layer.

The method of fabricating a protective layer for a PDP wherein depositing the body layer includes depositing MgO onto the doping source layer and crystallizing the MgO on the doping source layer.

The method of fabricating a protective layer for a PDP may further include diffusing at least one dopant from the doping source layer to MgO while MgO is crystallized.

At least one of the above and other features and advantages may also be realized by providing a PDP including a first substrate and a second substrate that are facing each other, a barrier rib between the first substrate and the second substrate and defines a plurality of discharge cells by dividing a discharge gap between the first substrate and the second substrate, a discharge electrode pair disposed across the plurality of discharge cells, a first dielectric material layer formed on the discharge electrode pair, a protective layer formed on the first dielectric material layer, an address electrode disposed to cross the discharge electrode pair, a second dielectric material layer formed on the address electrode, and fluorescent material layers disposed in each of the plurality of discharge cells, wherein the protective layer includes a doping source layer containing at least one dopant, and includes a body layer which contacts the doping source layer and includes the at least one dopant diffused from the doping source layer.

The discharge electrode pair may include a sustain electrode and a scan electrode, wherein each sustain electrode and scan electrode may include a transparent electrode and a bus electrode.

The doping source layer may contain at least one of a donor dopant and an acceptor dopant. The doping source layer may include a first doping source layer containing a donor dopant and an acceptor dopant and a second doping source layer containing an accept dopant. The first doping source layer may be formed on portions of the first dielectric material layer above regions where the transparent electrodes are disposed. The second doping source layer may be formed on a portion of the first dielectric material layer above a discharge gap region between a pair of transparent electrodes.

A width of the second doping source layer may be smaller than that of a discharge gap between transparent electrodes of the discharge electrode pair. The width of the second doping source layer may be about 0.01 μm to about 70 μm.

The body layer may include MgO, wherein a size of a crystal of an MgO region contacting the doping source layer may be larger than that of a crystal of an MgO region contacting the first dielectric material layer.

### BRIEF DESCRIPTION OF THE DRAWINGS

The above and other features and advantages will become more apparent to those of ordinary skill in the art by describing in detail exemplary embodiments with reference to the attached drawings, in which:

FIGS. 1A and 1B illustrate diagrams of a doping source layer in a method of forming a protective layer for a PDP according to an embodiment;

FIGS. 2A and 2B illustrate diagrams of a doping source layer in a method of forming a protective layer for a PDP according to another embodiment;

FIGS. 3A and 3B illustrate diagrams of a doping source layer in a method of forming a protective layer for a PDP according to another embodiment;

FIGS. 4A and 4B illustrate doping source layers being formed to have a predetermined pattern by applying a source material in a form other than droplets according to another embodiment;

FIGS. 5A through 5F illustrate sectional views for describing embodiments of protective layers for a PDP;

FIG. 6 illustrates an exploded perspective view of a PDP according to an embodiment;

FIG. 7 illustrates a sectional view of the PDP, obtained along a line I-I of FIG. 6;

FIG. 8 illustrates a scanning electron microscope (SEM) picture of a protective layer for a PDP according to an embodiment;

FIG. 9 illustrates a line graph showing current characteristics of a protective layer for a PDP according to an embodiment;

FIG. 10 illustrates a bar graph showing discharge time delay characteristics of a protective layer for a PDP according to an embodiment; and

FIG. 11 illustrates a bar graph showing wall charge loss characteristics of a protective layer for a PDP according to an embodiment.

### DETAILED DESCRIPTION

Korean Patent Application No. 10-2008-0124299, filed on December 8, 2008, in the Korean Intellectual Property Office, and entitled: “Protective Layer for Plasma Display Panel, Method of Preparing the Protective Layer, and Plasma Display Panel Including the Protective Layer,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A protective layer for a PDP according to the embodiments, a method of forming the protective layer, and a PDP including the protective layer will be described hereinafter with reference to attached drawings. First, embodiments for forming a doped source layer for a protective layer for a PDP will be described.

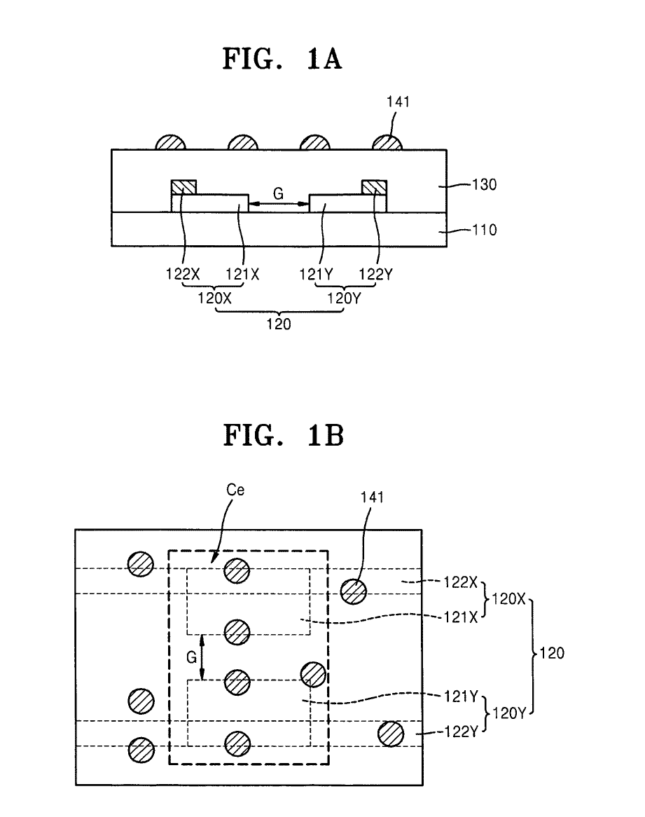

FIG. 1A illustrates a cross-sectional view of a protective layer according to an embodiment. FIG. 1B illustrates a plan view of the protective layer of FIG. 1 A.

Referring to FIGS. 1A and 1B, a discharge electrode pair 120 crossing discharge cells may be formed on a first substrate 110. The discharge electrode pair 120 may include a sustain electrode 120X and a scan electrode 120Y. The sustain electrode 120X may include a transparent electrode 121X and a bus electrode 122X, and the scan electrode 120Y may also include a transparent electrode 121Y and a bus electrode 122Y.

The transparent electrodes 121X and 121Y may be formed of a transparent, conductive material for efficiently transmitting light from discharge cells Ce to outside. The transparent, conductive material may be a thin film ITO. The bus electrodes 122X and 122Y may be formed of a conductive material with excellent conductivity, e.g., silver, aluminum, copper, nickel, etc.

The bus electrodes 122X and 122Y may have line shapes extending across the discharge cells Ce. The transparent electrodes 121X and 121Y may respectively protrude from the bus electrodes 122X and 122Y into the discharge cell Ce. More particularly, referring to FIG. 1B, the bus electrodes 122X and 122Y may have line shapes extending across the discharge cell Ce in parallel to each other, and the transparent electrodes 121X and 121Y may be formed to protrude from the bus electrodes 122X and 122Y, respectively, into the discharge cell Ce, e.g., toward the center of the discharge cell Ce. A discharge gap G between the transparent electrodes 121X and 121Y may be formed at the center of the discharge cell Ce.

The discharge electrode pair 120 may be formed according to methods, e.g., vapor deposition, photolithography, etc.

A source material, shape, arrangement, etc., of the discharge electrode pair 120 are merely examples, and thus, the present embodiment may not be limited thereto. For example, positions of the bus electrode and the transparent electrode may be changed, and the transparent electrode may be shaped differently.

A first dielectric material layer 130 may be formed on the first substrate 110 to cover the discharge electrode pair 120. Thus, damage to the discharge electrode pair 120 due to collision with charged particles may be prevented.

A first doping source layer 141 may be formed on the first dielectric material layer 130. The first doping source layer 141 according to the current embodiment may be formed on the first dielectric material layer 130 using methods, e.g., spraying, printing, dipping, spin coating, etc. For example, the first doping source layer 141 may be formed by spraying a solution prepared by dissolving a dopant in a solvent onto the first dielectric material layer 130.

Conventionally, the properties of dopant in MgO and the fine structure of MgO formed due to the dopant may be lost during a deposition operation, and thus, a protective layer may not act efficiently. In other words, it may be difficult to maintain the bulk property of the source material for forming the protective layer.

Furthermore, when a donor dopant is doped into a source material for forming a conventional protective layer, a discharge time delay may be reduced due to smooth discharge of electrons. Thus, full high definition (FHD) single-scan may become possible. As wall charge loss increases, however, discharge stability may deteriorate. In contrast, when an acceptor dopant is additionally doped in the source material, wall charge loss may be reduced, but a discharge time delay may become too slow for FHD single-scan application. Therefore, to reduce both the discharge time delay and wall charge loss, a source material doped with both the donor dopant and the acceptor dopant at the same time may be prepared, and a protective layer fabricated by either depositing the above prepared the source material or by depositing a MgO source materials including a MgO source material with the donor dopant and a MgO source with the accept dopant may be prepared. Since the dopants exhibit strong reciprocal actions, however, problems due to conflicting properties of the donor dopant and acceptor dopant may occur.

However, according to embodiments, by indirectly doping a dopant using the first doping source layer 141, rather than directly doping a dopant into MgO, the bulk property of the source material for forming the protective layer may be maintained without incurring problems due to conflicting properties of the donor dopant and acceptor dopant. The dopant amount in 100 parts by weight in the solution may be from about 0.001 parts to about 50 parts by weight. According to a conventional direct doping method, a dopant may be doped into MgO according to solubility of the dopant and may be crystallized with thermodynamic equilibrium. However, since doping may take place under a thermodynamic unbalanced condition in the present embodiment, the dopant amount be doped into MgO may be determined according to discharge characteristics.

If the dopant amount is less than 0.001 parts by weight, doping may be ineffective. In contrast, if the dopant amount is higher than 50 parts by weight, crystallinity of MgO may deteriorate during doping and, thus, a cell discharge may not be performed smoothly and a sputtering resistance may decrease.

The solvent may be an organic solvent, e.g., ethanol, etc. Furthermore, if required, various additives may be added to the solution. The dopant may either be a donor dopant which stimulates MgO to discharge electrons to reduce a discharge starting voltage and discharge time delay, or an acceptor dopant which inhibits MgO from discharging electrons to reduce a wall charge loss and a current loss. Furthermore, the dopant may include both a donor dopant and an acceptor dopant. Examples of the donor dopant and the acceptor dopant are shown in Table 1 below.

TABLE 1

| | | | | | | | | | |
|---|---|---|---|---|---|---|---|---|---|
| Donor | Scandium | Aluminum | Yttrium | Gallium | Boron (B) | Lanthanum | Cerium | Praseodymium | Nd |
| Dopant | (Sc) | (Al) | (Y) | (Ga) | | (La) | (Ce) | (Pr) | (Neodymium) |
| | Samarium | Europium | Gadolinium | Terbium | Dysprosium | Holmium | Ytterbium | Silicon (Si) | Cesium (Ce) |
| | (Sm) | (Er) | (Gb) | (Tb) | (Dy) | (Ho) | (Yb) | | |
| | Fluorine | Hydrogen | Erbium | | | | | | |
| | (F) | (H) | (Er) | | | | | | |
| Acceptor | Lithium | Sodium | Potassium | Silver | Copper | Nickel (Ni) | Calcium | Strontium (Sr) | Barium (Ba) |
| Dopant | (Li) | (Na) | (K) | (Ag) | (Cu) | | (Ca) | | |
| | Vanadium | Zinc (Zn) | Chromium | Indium | Hafnium | Zirconium | Germanium | Carbon (C) | |
| | (V) | | (Cr) | (In) | (Hf) | (Zr) | (Ge) | | |

According to the current embodiment, a donor dopant, an acceptor dopant, or a solution prepared by dissolving a mixture thereof in a solvent may be prepared and may be randomly sprayed onto the first dielectric material layer 130. Accordingly, the first doping source layer 141 may be irregularly formed, e.g., the first doping source layer 141 is not in any predetermined pattern, on the first dielectric material layer 130, as illustrated in FIG. 1B. After the solvent is applied onto the first dielectric material layer 130, a drying operation and/or a firing operation may be performed. During these operations, organic contents contained in droplets of the solvent may be vaporized and/or may be incinerated. As the result, mass of the first doping source layers 141 may be reduced, and thus, density of the first doping source layer 141 may become high due to oxidization of content elements, etc. Accordingly, the first doping source layer 141, which is solid and has low mass and high density, may be formed.

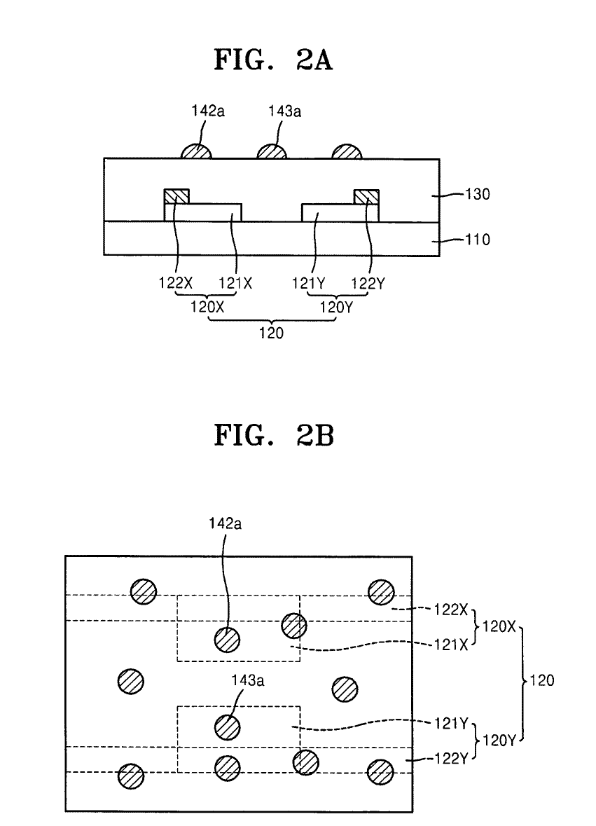

Referring to FIGS. 2A and 2B, formation of doping source layers according to another embodiment is described below. FIG. 2A illustrates a cross-sectional view of a protective layer according to another embodiment. FIG. 2B illustrates a plan view of the protective layer of FIG. 2A.

First, at least two types of solutions in which dopants are dissolved may be prepared. For example, a first solution in which a donor dopant is dissolved and a second solution in which an acceptor dopant is dissolved may be prepared. Alternatively, the first solution in which a donor dopant is dissolved, a third solution, in which an acceptor dopant and a donor dopant are dissolved, may be prepared. Alternatively, the above second solution and the above third solution may be prepared as the two types of the solution. Alternatively, a solution in which at least one of the dopants is dissolved and a solution in which at least one of elements is dissolved may be prepared.

Accordingly, at least two types of solutions may be prepared and sprayed onto the first dielectric material layer 130. Therefore, a first doping source layer 142a and a second doping source layer 143a may be formed by each applying one of the two solutions in the two types of solutions prepared. According to the current embodiment, the first doping source layer 142a and the second doping source layer 143a may be irregularly formed on the first dielectric material layer 130 by randomly applying any of the above-described two types of solutions.

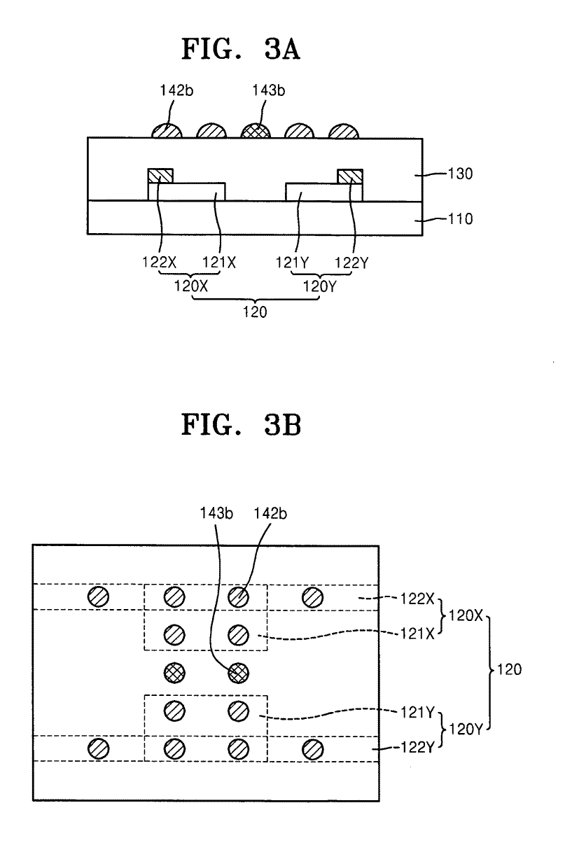

Referring to FIGS. 3A and 3B, formation of a doping source layer according to another embodiment is described below. FIG. 3A illustrates a cross-sectional view of a protective layer according to another embodiment. FIG. 3B illustrates a plan view of the protective layer of FIG. 3A.

First, as described above, two types of solutions may be prepared. Since a donor dopant stimulates electron discharge, a solution containing a donor dopant may be applied onto a region of the first dielectric material layer 130, above the discharge electrode pair 120 to which a discharge voltage is applied, to form a first doping source layer 142b. Therefore, a discharge starting voltage and a discharge time delay may be reduced because of the donor dopant stimulating electron discharge during a cell discharge, and thus, a cell discharge may easily occur. In contrast, a solution containing an acceptor dopant, which can reduce a wall charge loss by inhibiting a cell discharge, may be applied onto a region of the first dielectric material layer 130 to form a second doping source layer 143b. The second doping source layer 143b may be formed in the discharge gap G between the sustain electrode 120X and the scan electrode 120Y. More particularly, the discharge gap G may include a space between transparent electrodes 121X and 121Y of the sustain electrode 120X and the scan electrode 120Y. Therefore, a wall charge loss and discharge current may be reduced in a region of discharge cells including the discharge gap.

According to the current embodiment, the first doping source layer 142b may be formed by applying the third solution, which contains both the donor dopant and the acceptor dopant, onto the region of the first dielectric material layer 130 which is above the discharge electrode pair 120. The second doping source layer 143b may be formed by applying the second solution, which contains the acceptor dopant, onto the region of the first dielectric material layer 130 which is above the discharge gap G. As described above, the first doping source layer 142b and the second doping source layer 143b may be formed onto desired regions of the first dielectric material layer 130 by using masks according to either a spraying method or an inkjet method.

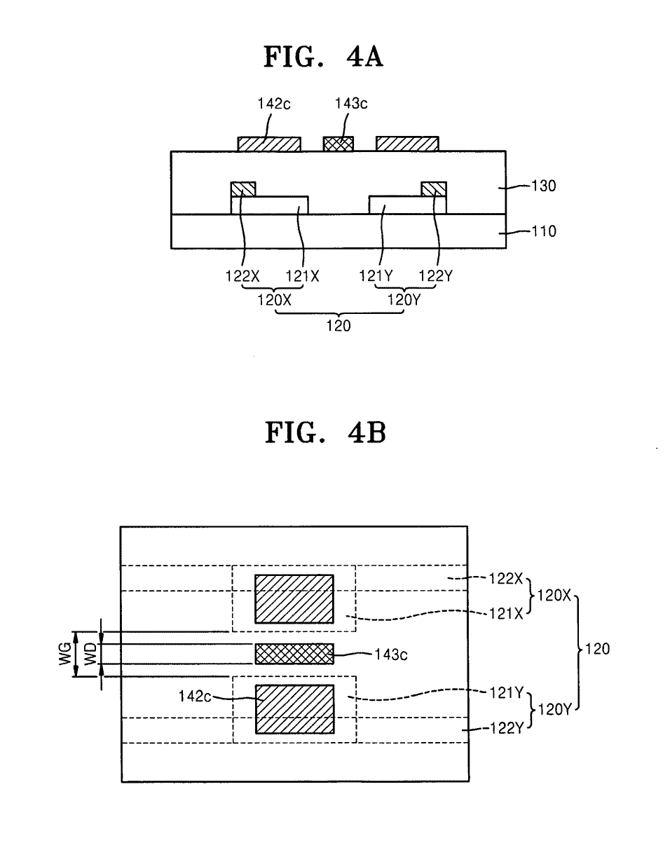

FIG. 4A and 4B illustrate doping source layers being formed to have a predetermined pattern by applying a source material in a form other than droplets according to another embodiment. A first doping source layer 142c containing a donor dopant may be formed on a region of the first dielectric material layer 130, which is above the discharge electrode pair 120. The first doping source layer 142c may be formed by applying the first solution. A second doping source layer 143c containing an acceptor dopant may be formed on a region of the first dielectric material layer 130 which is above the discharge gap G. The second doping source layer 143c may be formed by applying the second solution. The first doping source layer 142c and the second doping source layer 143c may be formed in desired regions of the first dielectric material layer 130 to have a predetermined pattern by using masks according to various methods, e.g., screen printing, slit coating, photolithography, etc.

A width WD of the second doping source layer 143c that is above the discharge gap G may be smaller than a width WG of the discharge gap G. If the width WD of the second doping source layer 143c is greater than the width WG of the discharge gap G, a current may flow between the sustain electrode 120X and the scan electrode 120Y. Thus, cell discharge current loss and wall charge loss may occur. As the result, the cell discharge may not be performed smoothly.

Generally, a width of the discharge gap G is approximately 70 μm, and thus, the second doping source layer 143c may be formed to have a width between about 0.01 μm and about 70 μm. If the width WD of the second doping source layer 143c is smaller than 0.01 μm, doping may not be effective. If the width WD of the second doping source layer 143c is greater than 70 μm, the second doping source layer 143c may have the width WD greater than that of the discharge gap G, and thus, a discharge current may flow between the sustain electrode 120X and the scan electrode 120Y as described above. As the result, the cell discharge may not be performed smoothly.

While the current embodiment provides an exemplary width with respect to a doping source layer having a predetermined pattern, a doping source layer having a droplet shape may have the same exemplary width. More particularly, the width of a droplet may be smaller than that of the discharge gap G.

Although various embodiments of a doping source layer have been described above, the doping source layer of embodiments is not limited thereto. According to the present embodiments, the doping source layers 142c and 143c may be formed on the first dielectric material layer 130 by indirectly doping a dopant using the doping source layer instead of directly doping a dopant into MgO. Alternatively, a doping source layer may be formed after partially depositing MgO, and then depositing remaining MgO so that a dopant may be diffused within MgO. In other words, a doping source layer may be formed within a body layer formed of MgO.

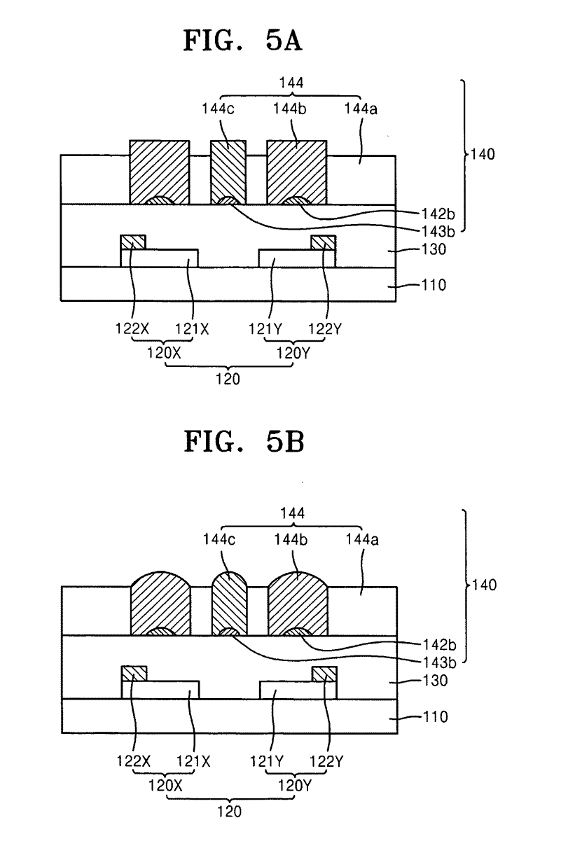

MgO may be deposited onto the doping source layers described above. Either a MgO single-crystal tablet or a MgO polycrystal pellet may be deposited onto the doping source layers by using, e.g., e-Beam deposition equipment. Various embodiments of a protective layer formed by depositing MgO will be described below with reference to FIG. 5A through 5F.

The current embodiment provides various types of a protective layer 140 formed by depositing MgO when the first doping source layer 142b and the second doping source layer 143b may be regularly applied, e.g., according to a predetermined pattern, onto the first dielectric material layer 130 as illustrated in FIGS. 3A and 3B.

Referring to FIG. 5A, a body layer 144 may be formed by depositing a MgO source material onto the first doping source layer 142b and the second doping source layer 143b. The MgO source material may be a MgO single-crystal tablet or a MgO polycrystal pellet. While the MgO source material is deposited, dopants contained in the doping source layers 142b and 143b may be diffused toward the body layer 144. The dopants may be diffused better in a vertical direction than in a horizontal direction by forming the body layer 144 to have a small thickness. Generally, the thickness of the body layer 144 may be smaller than or equal to about 1 μm.

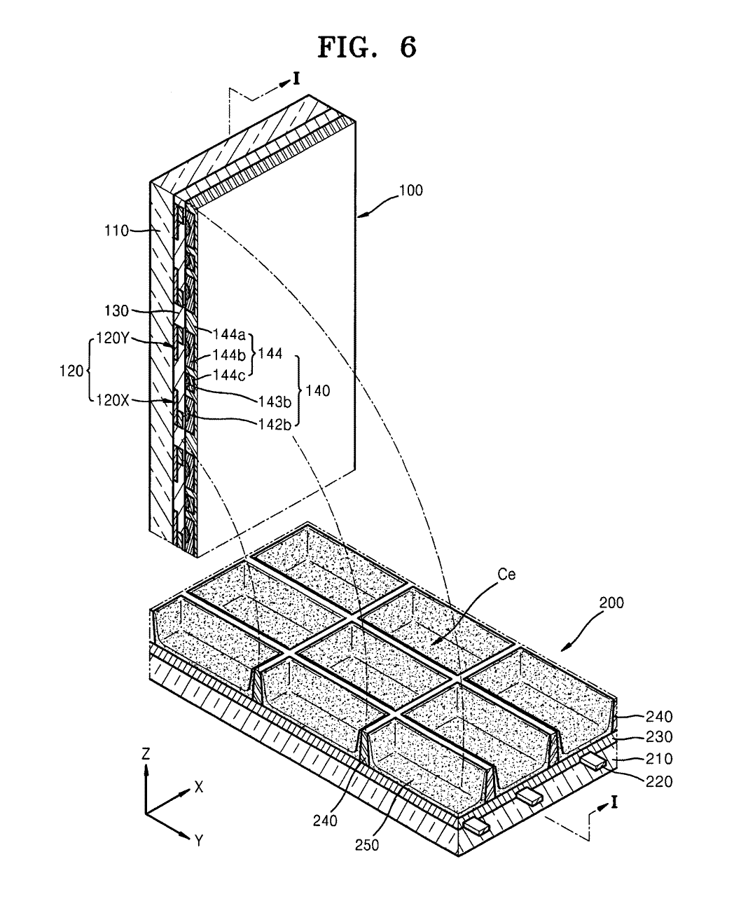

Furthermore, the doping source layers 142b and 143b may favor generation of a crystal core, and thus, a MgO crystal may grow rapidly around the doping source layers 142b and 143b. Compared to MgO deposited onto the first dielectric material layer 130, which has smooth surfaces and is amorphous, the MgO crystal deposited around the doping source layers 142b and 143b may grow faster. Difference in sizes of crystals will be described below in detail with reference to FIG. 8.

Furthermore, referring to FIG. 5A, the body layer 144 may include a first MgO region 144a deposited and crystallized on the first dielectric material layer 130, a second MgO region 144b deposited and crystallized on the first doping source layer 142b, and a third MgO region 144c deposited and crystallized on the second doping source layer 143b.

The second MgO region 144b may contain a donor dopant diffused from the first doping source layer 142b. The third MgO region 144c may contain an acceptor dopant diffused from the second doping source layer 143b.

Since the doping source layers 142b and 143b favor growth of a crystal core, the second MgO region 144b and the third MgO region 144c grown from the doping source layers 142b and 143b may be crystallized faster than the first MgO region 144a. Thus, surfaces of the second and the third MgO regions may protrude. The protrusions may have flat shapes, e.g., a rectangular shape.

In the current embodiment, the second MgO region 144b and the third MgO region 144c may separately and vertically extend from the doping source layers 142b and 143b, respectively. The vertical extension may help the dopants diffuse well in a vertical direction. However, embodiments are not limited to the regular separation of the first MgO region 144a and the second and third MgO regions 144b and 144c in the vertical direction as illustrated in FIG. 5A.

Furthermore, the current embodiment shows that dopants diffuse into the top surface of the body layer 144 from the doping source layers 142b and 143b. Therefore, not only the first MgO region 144a, but also the second and third MgO regions 144b and 144c may be formed to be exposed. For example, the end of the second and third MgO regions 144b and 144c may not be covered.

FIG. 5B illustrates that protrusions of the second MgO region 144b and the third MgO region 144c may have gently curved shapes, rather than having the flat shapes as illustrated in FIG. 5A.

The protective layer 140 according to an embodiment may include the doping source layers 142b and 143b and the body layer 144 formed on the doping source layers 142b and 143b as well as on the first dielectric material layer 130. The body layer 144 may include the first MgO region 144a, which may be crystallized on the first dielectric material layer 130, and the second and third MgO regions 144b and 144c, which may be crystallized on the doping source layers 142b and 143b, so that a dopant diffuses into the top surface of the protective layer 140.

According to another embodiment, a case in which an effect of the doping source layers 142b and 143b with respect to crystal growth may be minimized is provided below. Referring to FIG. 5C, MgO is crystallized on the doping source layers 142b and 143b, thereby forming the second MgO region 144b and the third MgO region 144c. Then, the first MgO region 144a may be formed by crystallizing MgO on the first dielectric material layer 130. In the current embodiment, the doping source layers 142b and 143b have a smaller effect with respect to crystal growth as compared to the previous embodiment. Thus, the second MgO region 144b and the third MgO region 144c may be formed with almost the same speed of crystal growth as the first MgO region 144a. Therefore, the overall heights of the second MgO region 144b and the third MgO region 144c may be identical to the height of the first MgO region 144a. Furthermore, the second MgO region 144b in which a donor dopant diffused and the third MgO region 144c in which an acceptor dopant diffused may be formed to be exposed. For example, the donor dopant and the acceptor dopant may be diffused from the doping source layers 142b and 143b, respectively, into the top surface of the protective layer 140.

FIG. 5D also illustrates an example in which an effect of the doping source layers 142b and 143b with respect to crystal growth is minimized. Therefore, an upper surface of the protective layer 140 may be smooth overall, i.e., substantially planar. A distance for diffusion of the dopants in the second and the third MgO regions 144b and 144c, however, may be relatively shorter compared to the diffusion illustrated in FIG. 5C, and thus, the first MgO region 144a may further be formed on the second MgO region 144b and the third MgO region 144c.

FIG. 5E illustrates another embodiment in which dopants provided by the doping source layers 142b and 143b may fail to diffuse into the top surface of the protective layer 140. Therefore, the first MgO region 144a may be further formed on the second MgO region 144b and the third MgO region 144c.

The doping source layers 142b and 143b, however, may favor generation of a crystal core. Thus, the second MgO region 144b and the third MgO region 144c formed on the doping source layers 142b and 143b may be formed faster than the first MgO region 144a. Therefore, a portion of the top surface of the protective layer 140, i.e., the portion above the doping source layers 142b and 143b, may have protrusions. FIG. 5E illustrates the protrusions formed above the doping source layers 142b and 143b being flat.

In contrast, FIG. 5F illustrates the protrusions being round. Except for shapes of the protrusions, FIG. 5F is identical to FIG. 5E. Thus, detailed descriptions thereof will not be repeated.

While various types of the protective layer 140 have been described above, embodiments are not limited thereto. Various embodiments regarding the shape of the MgO region containing the dopant based on diffusion direction and diffusion speed and etc, surface structure of the protective layer due to crystal growth, etc., may be possible.

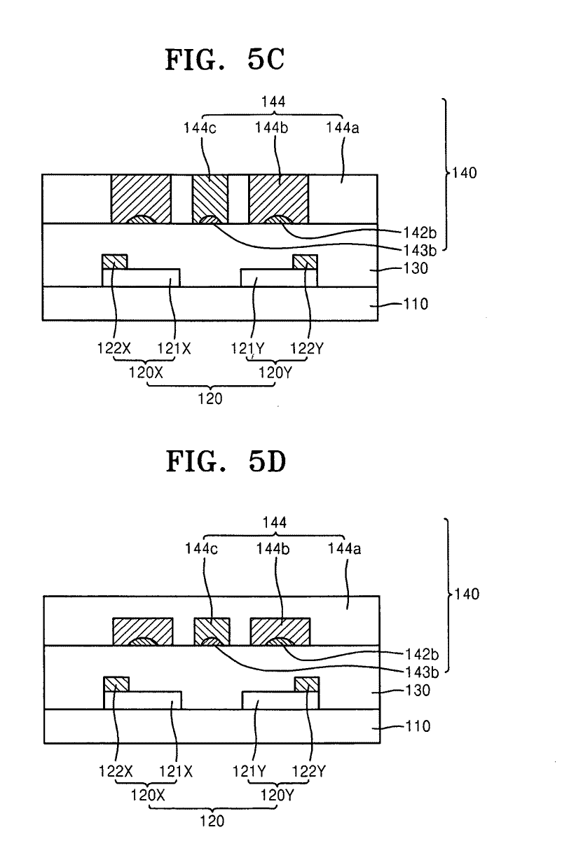

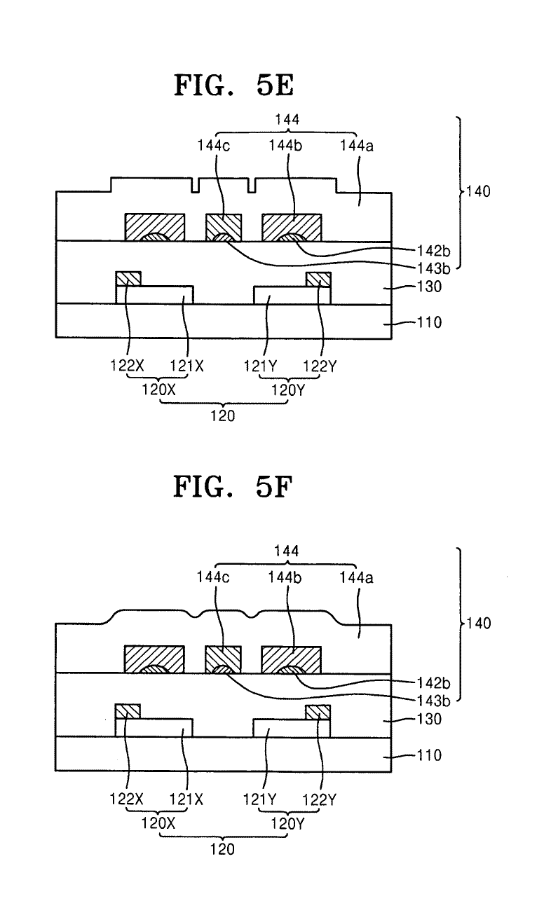

FIG. 6 illustrates an exploded perspective view of a PDP according to an embodiment. FIG. 7 illustrates a sectional view of the PDP, obtained along a line I-I of FIG. 6. Referring to FIGS. 6 and 7, the PDP may include a front panel 100 for emitting lights to the outside and a rear panel 200 including a fluorescent material that emits lights.

In the front panel 100, a plurality of discharge electrode pairs 120 may be disposed on the first substrate 110 in a line. The discharge electrode pair 120 may include the sustain electrode 120X and the scan electrode 120Y. Each sustain electrode 120X and scan electrode 120Y may include the transparent electrode and the bus electrode. The bus electrode may extend along the x-axis, and the transparent electrode may extend along the y-axis, either to the positive of the y-axis or to the negative of the y-axis from the bus electrode.

Then, the first dielectric material layer 130 and the protective layer 140 may sequentially be stacked on the first substrate 110 to cover the discharge electrode pair 120. The protective layer 140 may include the doping source layers 142b and 143b and the MgO body layer 144, e.g., polycrystal, containing a dopant diffused from the doping source layer. In the current embodiment, the protective layer 140 may include the first doping source layer 142 containing a donor dopant and the second doping source layer 143 containing an acceptor dopant. The first doping source layer 142 may be disposed on the transparent electrodes 121X and 121Y, and the second doping source layer 143 may be disposed on the discharge gap G between the transparent electrodes 121X and 121Y. Furthermore, the protective layer 140 may further include the body layer 144, wherein the body layer 144 may include the first MgO region 144a, which may be crystallized on the first dielectric material layer 130, the second MgO region 144b, which may be formed on the first doping source layer 142 and may contain a donor dopant diffused therefrom, and the third MgO region 144c, which may be formed on the second doping source layer 143 and may contain an acceptor dopant.

Therefore, the protective layer 140 according to the present embodiment may maintain a bulk feature of MgO containing a dopant. In other words, the present embodiment may resolve problems related to reduction of dopant concentration to dopant loss and/or impurity indraft during deposition in case where a dopant is doped into a MgO source material in advance and a protective layer is formed of the MgO source material. Therefore, a desired protective layer, which may be formed of a body layer, e.g., MgO, containing a dopant, may be formed by controlling the size, distribution, and dopant concentration of a doping source layer. Furthermore, since types and locations of a dopant may also be controlled, a cell discharge may be improved by reducing a discharge starting voltage and a discharge time delay.

Next, the rear panel 200 will be described below. In the rear panel 200, a plurality of address electrodes 220, which extend in the y-axis, may be disposed on a second substrate 210. A second dielectric material layer 230 may be disposed to cover the address electrode 220, and a barrier rib 240 defining discharge cells may be formed. Thus, the plurality of discharge cells Ce may be formed. Then, a discharge gas that generated ultraviolet (UV) light may be injected into the discharge cells Ce. The discharge gas may be a multi-component gas containing predetermined ratio of xenon (Xe), krypton (Kr), helium (He), neon (Ne), etc., and may generate an appropriate amount of UV light via a discharge excitation.

In particular, use of the protective layer 140 according to the present embodiments may reduce a discharge starting voltage, a high Xe discharge gas, which contains at least 10 volume percent of Xe in every 100 volume percent of the discharge gas, may be used. Although the high Xe discharge gas has high light emitting efficiency, it may require a high discharge starting voltage. Therefore, considering that typically a circuit has to be redesigned to accommodate increased driving power consumption resulting from increased discharge starting voltage, practical or extensive applications of the high Xe discharge gas has been limited. Since the protective layer according to the present embodiment, however, may reduce a discharge starting voltage, shortcomings of using the high Xe discharge gas may be compensated.

Furthermore, a fluorescent material layer 250 may be disposed within the discharge cells Ce. The fluorescent material layer 250 may be disposed on sidewalls of the barrier rib 240 and on the second dielectric material layer 230. More particularly, different fluorescent material layers 250 may be disposed within the plurality of discharge cells Ce. For example, a red fluorescent material layer, a green fluorescent material layer, and a blue fluorescent material layer may be disposed within each of the discharge cells Ce.

Referring to FIG. 7, the discharge cell Ce may be formed as an independent light emitting region, which may be separated from adjacent discharge cells Ce by the barrier rib 240. More particularly, the discharge cell Ce may include the pair of discharge electrode pairs 120 and the address electrode 220 extending to cross the discharge electrode pairs 120. Each of the discharge electrode pairs 120 may include the sustain electrode 120X and the scan electrode 120Y. The sustain electrode 120X may include the transparent electrode 121X and the bus electrode 122X. The scan electrode 120Y may include the transparent electrode 121Y and the bus electrode 122Y.

Voltages may alternately be applied to the discharge electrode pair 120 so that a mutual display discharge occurs, and an address discharge may occur between the scan electrode 120Y and the address electrode 220 prior to the mutual display discharge. The address discharge may correspond to pre-process discharge, and thus, may cause a display discharge due to accumulate priming particles within the discharge cell so that light may be emitted to the outside.

For single-scan driving in an HD or FHD PDP, at least 480 scan electrodes 120Y may be required for the PDP. The PDP may be driven with single-scan by performing a pre-process discharge by sequentially applying scan signals to the scan electrodes 120Y. The single-scan driving requires sequentially driving 480 scan signals during one frame. Thus, an address discharge duration may increase in case of a long discharge time delay. The protective layer 140 according to the present embodiment, however, may reduce a discharge time delay by arranging a donor dopant and an acceptor dopant in appropriate locations. Thus, the protective layer 140 may have a discharge feature suitable for minimum single-scan driving for an HD PDP. While a conventional protective layer may exhibit strong reciprocal action between a donor dopant and an acceptor dopant, an indirect doping method using a doping source layer according to embodiments may prevent such reciprocal actions.

Embodiments of protective layers according to the present embodiment and PDPs including the same will be described below. Furthermore, comparative embodiments will also be described. Furthermore, examples of examinations regarding discharge features of the embodiments will also be described to determine improvements in a discharge feature of a protective layer according to the present embodiment.

### Protective Layer, Embodiment 1

A Lithium (Li) solution for a first doping source layer is prepared by dissolving 1 g of LiNO₃ (FW 68.95, mp 264° C.) in 10 g of ethanol. The Li solution is evenly sprayed onto a surface of a dielectric material substrate for 1 second at an air pressure 0.3M Pa from a distance of 30 cm. Then, the substrate is dried for 1 hour at a temperature of 300° C. to form a first solid doping source layer. A protective layer is fabricated by depositing MgO onto the dielectric material substrate, on which the first doping source layer is formed, by using e-Beam deposition equipment at a temperature of 250° C.

### Protective Layer, Embodiment 2

A protective layer including a second doping source layer is fabricated according to the same method used for the protective layer in embodiment 1, except that scandium (Sc) is used instead of Li.

### Protective Layer, Embodiment 3

A protective layer including a third doping source layer is fabricated according to the same method used for the protective layer in embodiment 1, except that a mixture of Li and Sc is used instead of Li.

### PDP, Embodiment 1

Silver (Ag) is applied onto a glass substrate (35 mm×22.5 mm, 2.8 mm thickness) using a screen printing method, dried, and fired to fabricate a discharge electrode pair. Then, a dielectric material layer (dielectric constant=13, thickness=39 μm) is formed using the screen printing method. A first doping source layer is formed on the dielectric material layer, and MgO is deposited onto the first doping source layer to form a protective layer. The protective layer is formed according to the same method used for the protective layer in embodiment 1. Accordingly, a top panel is completed. A bottom panel is fabricated by sequentially stacking an address electrode, a dielectric material layer, and a green fluorescent material layer on the glass substrate. Using a quartz barrier rib, the top panel and the bottom panel are separated from each other by 120 μm, are put into a vacuum chamber, and the vacuum chamber is exhausted for a predetermined duration of time. A discharge gas (Xe15%+He35%) at 350 Torr is injected into the chamber, and thus, is injected into a discharge space between the top panel and the bottom panel. Accordingly, an experimental cell of a PDP is fabricated.

### PDP, Embodiment 2

A PDP is fabricated according to the same method used for the PDP in embodiment 1, except that a protective layer is fabricated according to the method used in the protective layer in embodiment 2, instead of the method used in the protective layer in embodiment 1.

### PDP Embodiment 3

A PDP is fabricated according to the same method used for the PDP in embodiment 1, except that a protective layer is fabricated according to the same method used for the protective layer in embodiment 3 instead of the method used for the protective layer in embodiment 1.

### Protective Layer, Comparative Embodiment 1

A pallet is prepared by doping Li into MgO, and a protective layer is fabricated according to an e-Beam deposition method used for the protective layer in embodiment 1.

### Protective Layer, Comparative Embodiment 2

A protective layer is fabricated according to the same method used for the protective layer comparative in embodiment 1, except that Sc is used instead of Li.

### Protective Layer, Comparative Embodiment 3

A protective layer is fabricated according to the same method used for the protective layer in comparative embodiment 1, except that a mixture of Li and Sc is used instead of Li.

### PDP, Comparative Embodiment 1

A PDP is fabricated according to the same method used for the PDP in embodiment 1 by using a protective layer manufactured by the same method used for the protective layer in comparative embodiment 1.

### PDP, Comparative Embodiment 2

A PDP is fabricated according to the same method used for the PDP in embodiment 1 by using a protective layer manufactured by the same method used for the protective layer in comparative embodiment 2.

### PDP, Comparative Embodiment 3

A PDP is fabricated according to the same method as used for the PDP in embodiment 1 by using a protective layer manufactured by the same method used for the protective layer in comparative embodiment 3.

21 Examination 1>

Sizes of crystals are identified by obtaining a scanning electron microscope (SEM) photograph of the surface of the protective layer in embodiment 1. Referring to FIG. 8, which illustrates the SEM photograph of a protective layer for PDP, it is clear that a MgO region X formed on a first doping source layer and a MgO region Y formed on a dielectric material layer may have different crystal sizes. More particularly, size of particles of the MgO region X crystallized nearby the first doping source layer may be larger than that of the MgO region Y crystallized nearby the dielectric material layer, because the first doping source layer contains more steps and terraces helping crystal growth.

<Examination 2>

In this examination, a current feature of a PDP including a protective layer according to the present embodiment is examined. Current and brightness are measured when a cell discharge occurs in response to a power signal in a square wave form (30 kHz, duty 30%, amplitude 320 V) with respect to the PDP in embodiment 1. Furthermore, as a comparative embodiment, a PDP fabricated according to the same method used for the PDP in embodiment 1 by using a protective layer including no doping source layer is driven according to the above-described method, and current and brightness are measured.

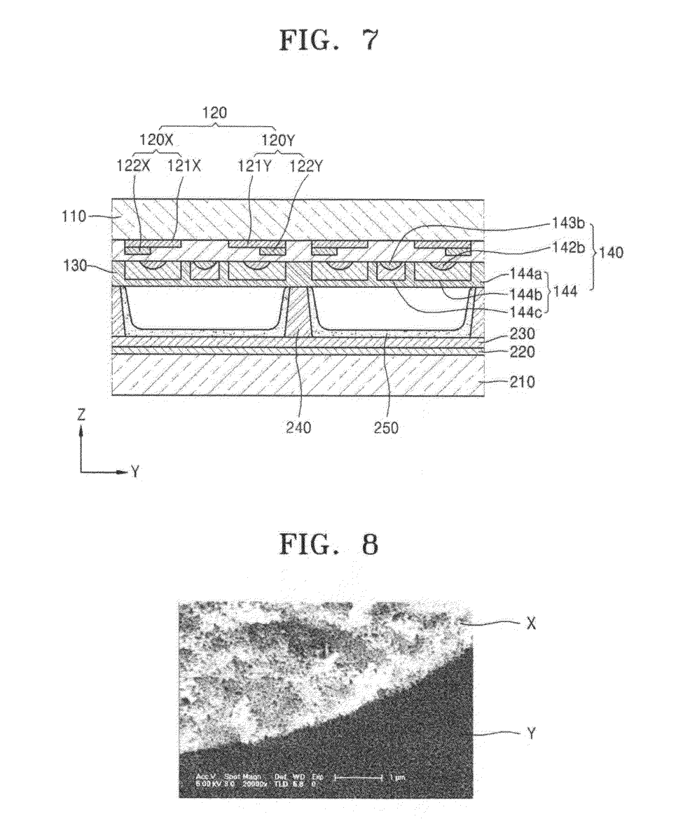

Referring to FIG. 9, the current may be reduced by approximately 25% in the PDP in embodiment 1 (line A) as compared to the PDP according to the comparative embodiment, i.e., same as the PDP in embodiment 1 except no doping source layer, (line R). Further, green brightness may be increased by approximately 50% in the PDP in embodiment 1 (line A) as compared to the PDP according to the comparative embodiment (line R). Therefore, it is clear that brightness/power consumption of the PDP in embodiment 1 may be improved by approximately 70% as compared to the PDP according to the comparative embodiment.

<Examination 3>

In this examination, delay times with respect to the comparative embodiment of examination 2, the PDPs in embodiments 1 through 3, and the PDPs in comparative embodiments 1 through 3 are examined.

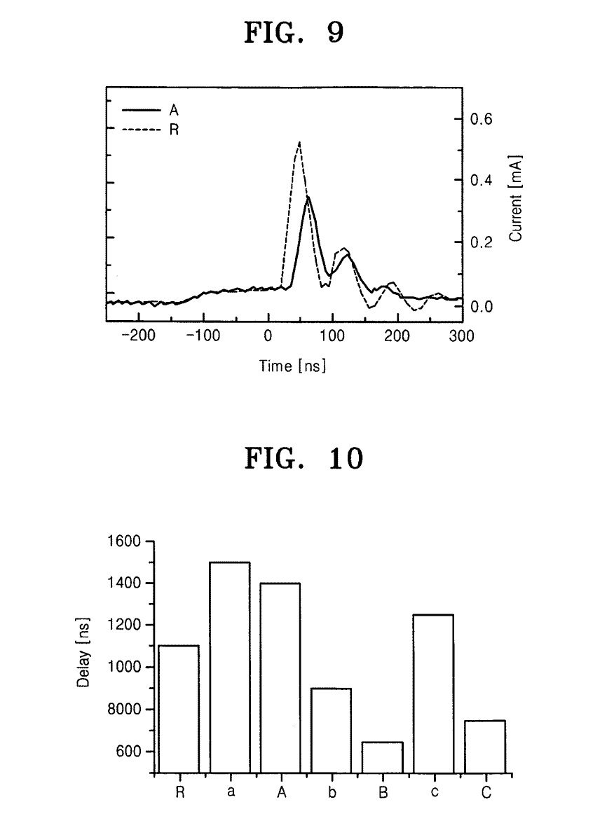

Referring to FIG. 10, a delay time of the PDP in embodiment 1 (bar A) may be slightly longer than that of the comparative embodiment (bar R), but may be shorter than that of the PDP in comparative embodiment 1 (bar a). Furthermore, it is clear that delay times of the PDPs in embodiment 2 (bar B) and embodiment 3 (bar C) may significantly be shorter than those of not only the comparative embodiment (bar R), but also the PDP in comparative embodiment 2 (bar b) and the PDP in comparative embodiment 3 (bar c).

<Examination 4>

In this examination, wall charge losses with respect to the comparative embodiment of examination 2, the PDPs in embodiments 1 through 3, and the PDPs in comparative embodiments 1 through 3 are examined.

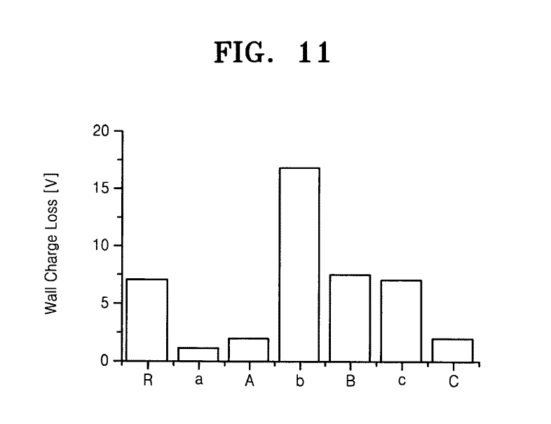

Referring to FIG. 11, it is clear that wall charge losses of the PDP in embodiment 1 (bar A), the PDP in embodiment 2 (bar B), and the PDP in embodiment 3 (bar C) may be reduced to less than 50% of that of the comparative embodiment (bar R). Furthermore, it is also clear that wall charge losses of the PDP in embodiment 1 (bar A), the PDP in embodiment 2 (bar B), and the PDP in embodiment 3 (bar C) may significantly be reduced as compared to the PDP in comparative embodiment 1 (bar a), the PDP in comparative embodiment 2 (bar b), and the PDP in comparative embodiment 3 (bar c).

Referring to examinations 3 and 4, the comparative embodiment (bar R) may have a delay time of approximately 100 ns and a wall charge loss of approximately 7 V. The PDP in comparative embodiment 1 (bar a) may have a longer time delay but a smaller wall charge loss as compared to the comparative embodiment (bar R). The PDP in comparative embodiment 2 (bar b) may have a shorter time delay but a significantly greater wall charge loss as compared to the comparative embodiment (bar R). Although the PDP in comparative embodiment 3 (bar c) may have a smaller wall charge loss as compared to the comparative embodiment (bar R), a time delay may be too long, and thus, FHD single-scan may not be used. Therefore, it is clear that there may be a trade-off between the time delay and wall charge loss in conventional PDPs including protective layers formed according to conventional methods.

The PDP in embodiment 1 (bar A) may have a longer time delay but a significantly reduced wall charge loss as compared to the comparative embodiment (bar R), and is identical or superior to the PDP in comparative embodiment 1 (bar a) in the terms of the discharge time delay and wall charge loss.

The PDP in embodiment 2 (bar B) may have a shorter time delay as compared to the PDP in comparative embodiment 2 (bar b) and the comparative embodiment (bar R). Furthermore, the PDP in embodiment 2 (bar B) may have a wall charge loss similar to that in the comparative embodiment (bar R), but significantly greater to that of the PDP in comparative embodiment 2 (bar b).

The PDP in comparative embodiment 3 (bar c) may have a longer time delay than the PDP in embodiment 3 (bar C) due to negative reciprocal action, and thus, no improvement may be confirmed in the wall charge loss. The PDP in embodiment 3 (bar C), however, proves that the time delay and wall charge loss may be simultaneously improved over the PDP in embodiment 3 (bar c).

A protective layer according to the present embodiment may prevent loss of dopant, and thus, may maintain a bulk feature of MgO containing the dopant.

Furthermore, since a protective layer according to the present embodiment may include a doping source layer, the doping source layer may contribute to generation of a crystal core, and thus, a crystal may grow relatively faster. Due to fast crystal growth, large grains, e.g., individual crystalline particles, may be obtained. Thus, a protective layer according to the present embodiment may also advantageous for improving productivity.

Furthermore, since a first doping source layer containing a donor dopant and a second doping source layer containing an accept dopant may be formed and may freely be located according to the present embodiment, trade-offs/conflicts between a donor dopant and an accept dopant may be avoided.

Furthermore, a PDP according to the present embodiment may improve discharge efficiency and may reduce discharge time by having a protective layer described above. Thus, full high definition (FHD) may be realized.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A protective layer for a plasma display panel (PDP), the protective layer comprising:
a doping source layer containing at least one dopant; and
a body layer in contact with the doping source layer, the body layer including the at least one dopant diffused from the doping source layer.

2. The protective layer as claimed in claim 1, wherein the doping source layer contains at least one of a donor dopant, an acceptor dopant, or a mixture thereof.

3. The protective layer as claimed in claim 2, wherein the donor dopant is at least one of Sc, Al, Y, Ga, B, La, Ce, Pr, Nd, Sm, Eu, Gd, Tb, Dy, Ho, Yb, Si, Cs, F, H, or Er.

4. The protective layer as claimed in claim 2, wherein the acceptor dopant is at least one of Li, Na, K, Ag, Cu, Ni, Ca, Sr, Ba, V, Zn, Cr, In, Hf, Zr, Ge, or C.

5. The protective layer as claimed in claim 1, wherein the doping source layer includes a first doping source layer containing a donor dopant and a second doping source layer containing an acceptor dopant.

6. The protective layer as claimed in claim 5, wherein the donor dopant is at least one of Sc, Al, Y, Ga, B, La, Ce, Pr, Nd, Sm, Eu, Gd, Tb, Dy, Ho, Yb, Si, Cs, F, H, or Er.

7. The protective layer as claimed in claim 5, wherein the acceptor dopant is at least one of Li, Na, K, Ag, Cu, Ni, Ca, Sr, Ba, V, Zn, Cr, In, Hf, Zr, Ge, or C.

8. A method of fabricating a protective layer for a PDP, the method comprising:
forming a doping source layer containing at least one dopant on a first dielectric material layer;
drying the doping source layer; and
depositing a body layer onto the doping source layer.

9. The method as claimed in claim 8, further comprising forming a dielectric material layer on the substrate.

10. The method as claimed in claim 8, further comprising forming the doping source layer includes applying a solution containing the at least one dopant and a solvent onto the substrate using at least one of spraying, printing, dipping, spin coating, and inkjet method.

11. The method as claimed in claim 8, further comprising firing the doping source layer.

12. The method as claimed in claim 8, wherein depositing the body layer includes deposing MgO onto the doping source layer and crystallizing the MgO on the doping source layer.

13. The method as claimed in claim 12, further comprising diffusing at least one dopant from the doping source layer to MgO while crystallizing the MgO.

14. A PDP, comprising:
a first substrate and a second substrate facing each other;
a barrier rib between the first substrate and the second substrate and defines a plurality of discharge cells by dividing a discharge gap between the first substrate and the second substrate;
a discharge electrode pair disposed across the plurality of discharge cells;
a first dielectric material layer formed on the discharge electrode pair;
a protective layer formed on the first dielectric material layer;
an address electrode disposed to cross the discharge electrode pair;
a second dielectric material layer formed on the address electrode; and
fluorescent material layers disposed in each of the plurality of discharge cells,
wherein the protective layer includes:
a doping source layer containing at least one dopant; and
a body layer which contacts the doping source layer and includes the at least one dopant diffused from the doping source layer.

15. The PDP as claimed in claim 14, wherein the discharge electrode pair includes a sustain electrode and a scan electrode, wherein each sustain electrode and scan electrode includes a transparent electrode and a bus electrode.

16. The PDP as claimed in claim 14, wherein the doping source layer contains at least one of a donor dopant and an acceptor dopant.

17. The PDP as claimed in claim 14, wherein the doping source layer includes a first doping source layer containing a donor dopant and a second doping source layer containing an acceptor dopant.

18. The PDP as claimed in claim 17, wherein the first doping source layer is formed on portions of the first dielectric material layer above regions where the transparent electrodes are disposed, and
the second doping source layer is formed on a portion of the first dielectric material layer above a discharge gap region between a pair of transparent electrodes.

19. The PDP as claimed in claim 18, wherein a width of the second doping source layer is smaller than that of a discharge gap between transparent electrodes of the discharge electrode pair.

20. The PDP as claimed in claim 19, wherein the width of the second doping source layer is about 0.01 μm to about 70 μm.

21. The PDP as claimed in claim 14, wherein the body layer includes MgO, a size of a crystal of MgO region contacting the doping source layer is larger than that of a crystal of MgO region contacting the first dielectric material layer.
